(19) United States
(12) Patent Application Publication
(10) Pub. No.: US 2008/0148894 A1
(43) Pub. Date: Jun. 26, 2008

(54) DEVICE FOR CONTROLLING A GEARBOX

(76) Inventors: Georges Rapin, Thyez (FR); Marc De Bortoli, Artiguelouve (FR); Jean-Pierre Baz, Passy (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/954,968

(22) Filed: Dec. 12, 2007

(30) Foreign Application Priority Data
Dec. 12, 2006 (FR) 06/10835

(51) Int. Cl. F16H 59/02; G05G 5/00

(52) U.S. Cl. 74/473.21

(57) ABSTRACT

A device for controlling a gearbox, in particular for a motor vehicle, comprising a lever pivotably mounted in a fixed support and permanent magnets borne by a components integral with the lever or displaceable by the latter and cooperating by magnetic attraction or repulsion with permanent magnets mounted on the fixed support along the paths covered by the permanent magnets displaced by the lever for defining stable positions of the lever, detent ball forces applied to the lever between the stable positions and forces for restoring the lever towards its stable positions.

### FIELD AND BACKGROUND OF THE INVENTION

The invention relates to a device for controlling a gearbox, in particular for a motor vehicle, comprising a lever displaceable between predetermined neutral gear, gear selection and/or gear change positions.

From document EP-A-1429056, a lever device is known for controlling a gearbox, wherein means are provided for holding the lever in stable positions, which comprise a permanent magnet mounted at the lower end of the lever and cooperating by magnetic attraction with a first magnetic disc of a polarity opposite to that of the magnet of the lever, and by magnetic repulsion with other magnetic discs of a polarity identical to that of the magnet of the lever and which are positioned as a ring around the first disc in order to form a magnetic barrier around the latter.

This known device has the advantage of allowing the lever to be held accurately and with reduced play in predetermined positions, without any wear because of the absence of contact between the parts of the holding means, but it cannot provide the return of the lever when the latter is moved away from a predetermined position such as the neutral gear position, so as to be brought into a gear selection or gear change position. For this, it is necessary as in the prior art, to associate return springs with the lever of the known device, with all the drawbacks related to the use of these springs: sensitivity to vibrations and to environmental conditions, risks of breaking, aging, etc. It is also necessary to provide, between certain predetermined positions of the lever, mechanical detent ball means creating an intermediate hard point which is passed by applying to the lever a larger force than a threshold, which then guarantees the displacement of the lever as far as in the following predetermined position. The setting up and the use of these detent ball means are expressed by an increase in the cost and by wear of the parts in contact during repeated maneuvers of the lever.

### SUMMARY OF THE INVENTION

The object of the invention is notably to avoid these drawbacks of the prior art in a gearbox control device.

For this purpose, it proposes a device for controlling a gearbox, in particular for a motor vehicle, comprising a lever which may be displaced between predetermined neutral gear, gear selection and/or gear change positions, characterized in that it comprises at least one permanent magnet borne by a return component associated with the lever or displaceable by the lever and permanent magnets of opposite polarities alternately positioned on a fixed support along the path covered by the permanent magnet of the return component and respectively defining predetermined positions of the lever as well as detent ball forces between these predetermined positions and restoring forces towards these predetermined positions, and also compensating the plays of the lever.

An essential advantage of the device according to the invention is the suppression of spring return means and of mechanical detent ball means which are used in the prior art and of the drawbacks related to the use of such means.

Further, the displacement of the lever in a gear change position is facilitated when the restoring force for the lever in a selection mode is provided by a magnetic device according to the present invention, because the return springs in selection mode of the prior art produce a parasitic force which is resistant to a gear change. By means of the invention, it also becomes possible to adjust the force for a gear change independently of the force for gear selection.

The invention therefore allows more accurate positioning of the lever in its predetermined positions, a suppression of the plays in these positions and a smoother and more accurate control of gear selection and gear change.

According to another feature of the invention, applicable to a device for controlling a manual gearbox in which the return component actuates a selection cable or rod, the fixed support bears a central permanent magnet with a polarity opposite to that of the permanent magnet of the return component and which is placed between two permanent magnets with a polarity identical to that of the permanent magnet of the return component and which generates a restoring force in selection mode for this component and the lever.

With this feature of the invention, the return springs of the selection lever which were used previously in the prior art may be suppressed.

According to another feature of the invention, the lever bears a joint ball rotatably mounted in a spherical cage borne by the fixed support, the joint ball and the cage bearing permanent magnets with paired polarities in order to define a median position of the lever and two detent ball points located on either side of this median position.

Thus, the detent ball forces which have to be overcome in order to displace the lever in a direction for a gear change are independent of the restoring forces in selection mode of this lever.

In an embodiment of the invention, the joint ball bears a displaceable permanent magnet in front of three permanent magnets borne by the cage, these three magnets comprising a central magnet with a polarity opposite to that of the magnet of the joint ball and two end magnets with the same polarity as the magnet of the joint ball in order to define detent ball points upon changing gears.

In an alternative embodiment, the joint ball bears two diametrically opposite permanent magnets and the cage bears two groups of three magnets with alternating polarity, each group of three magnets being found along the path covered by a permanent magnet of the ball joint.

With this alternative embodiment, it is possible to increase the detent ball forces applied to the lever for changing the gears, as well as the force for maintaining the lever in a stable position.

When the gearbox controlled by the lever is an automatic or automated box of the PRND type with pulse control positions M, M+ and M− for changing gear, the positions P, R, N, D and M of the lever are defined by a permanent magnet borne by a return component or by the lever and by a group of permanent magnets of opposite polarity borne by the fixed support and positioned along the path covered by the permanent magnet of the lever when it is displaced in the positions P, R, N and D, these magnets being in alternation with permanent magnets of the same polarity as the magnet of the lever and which define detent ball points between the positions P, R, N and D.

The position M of the lever is defined by a permanent magnet with a given polarity and which is borne by the lever or by a return component displaceable by the lever between the M+ and M− positions when the lever is in the M position, and by a permanent magnet of opposite polarity which is mounted on the fixed support between two other permanent magnets with the same polarity as the magnet of the return component and which define detent ball forces in the M+ and M− positions and restoring forces for the lever in the M position.

The permanent magnets which are borne by the lever or by the return components are displaceable facing printed circuits bearing magnetic (magnetoresistance or Hall effect) cells the outputs of which are connected to a processing circuit determining the position of the lever from information detected by the cells.

In this case, the permanent magnets which are borne by the lever or by the return components may be of a larger length, so that a portion of these magnets is displaceable facing magnets borne by the fixed support and which define the predetermined positions of the lever and the detent ball points and/or the restoring forces and that another portion of these magnets is displaceable in front of the magnetic cells in order to determine the positions and the displacements of the lever.

Alternatively, it may be provided that the lever for example bears at its lower end, a permanent magnet displaceable facing a printed circuit mounted on the fixed support and bearing magnetic cells, the outputs of which are connected to a processing circuit determining the positions of the lever from information detected by the cells.

In this case, a single printed circuit is sufficient for detecting all the positions of the lever and its displacements.

In another alternative, it may provided that the lower end of the lever bears a permanent magnet located facing a first permanent magnet of opposite polarity, mounted on the fixed support, when the lever is in the N position or in neutral, two second magnets of the same polarity as the magnet of the lever being mounted on the fixed supports on either side of the first magnet on the trajectory of the end of the lever when it is displaced in its selection directions from neutral in order to generate forces for maintaining the lever in the neutral position, and two other magnets of the same polarity as the magnet of the lever, which are mounted on the fixed support on either side of the second magnets in order to generate forces for restoring the lever to the neutral position when the lever is in a selection position.

With this alternative embodiment, the selection return springs which were associated with the lever in the prior art may also be suppressed.

Finally, it is advantageous that the permanent magnets mounted on the fixed supports are borne by one or more magnetic shielding plates.

It is thereby possible to protect from magnetic fields generated by these permanent magnets, other circuits installed in close vicinity to the lever, such as for example a set of circuits for controlling the protective inflatable airbags.

### BRIEF DESCRIPTION OF THE DRAWINGS

The invention will be better understood and other features, details and advantages thereof will become more clearly apparent upon reading the description which follows, made with reference to the appended drawings wherein:

FIG. 1 is a schematic perspective view of a device for controlling a gearbox according to the prior art;

FIG. 2 is a schematic perspective view of this device as modified according to the invention;

FIG. 3 is a schematic perspective view of another device for controlling a gearbox according to the invention;

FIG. 4 is a schematic perspective view illustrating another feature of the control device according to the invention;

FIG. 5 is a schematic sectional view illustrating another feature of the invention;

FIG. 6 is a partial sectional view illustrating an alternative embodiment of the invention;

FIG. 7 is a schematic perspective view of a control device according to the invention;

FIG. 8 is a schematic sectional view of magnetic means for positioning and restoring in selection mode the lever of the device of FIG. 7.

### DETAILED DESCRIPTION

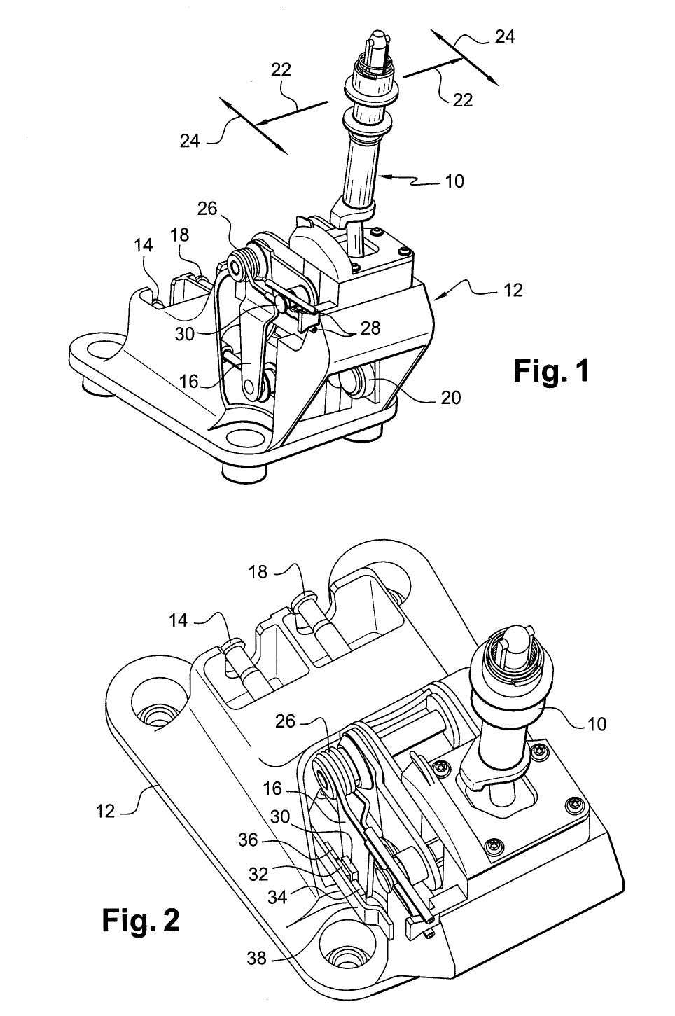

The device for controlling a gearbox schematically illustrated in FIG. 1 is a device from the prior art and essentially comprises a lever 10 pivotably mounted around a centre of rotation on a fixed support 12 for controlling a selection shaft of a gearbox by means of a selection cable or rod 14 actuated by the lever 10 via a return component 16, and for controlling the change or the engagement of a gear by means of a gear change rod or cable 18 driven by the lower end 20 of the lever 10.

The displacement directions of the lever for selecting gears from its neutral position illustrated in FIG. 1 are indicated by the arrows 22 and the displacement directions of the lever for engaging or changing gears are indicated by the arrows 24.

In this known device, restoring the lever to its neutral position after a displacement in selection mode, is provided by a spring 26, for example mounted on the pivot axis of the return component 16, and both parallel ends 28 of which cooperate with a transverse finger 30 integral with the lever and extending parallel to the selection direction between the ends 28 of the spring 26. It is understood that the spring 26 provides both holding of the lever in its neutral position and restoring the lever towards this position when it is moved away by displacement in the direction indicated by either one of the arrows 22.

The control device according to the invention which is schematically illustrated in FIG. 2 differs from the device of FIG. 1 in that the return component 16 bears, for example in the vicinity of its lower portion connected to the selection rod or cable 14, a permanent magnet 30 which is displaceable by the lever 10 parallel to the selection rod or cable 14, facing three permanent magnets 32, 34 and 36 mounted on a longitudinal arm 38 of the fixed support 12.

When the lever 10 is in the neutral position illustrated in FIG. 2, the magnet 30 borne by the return component 16 is facing the central magnet 32 mounted on the fixed arm 38 and the faces opposite both magnets have opposite polarities so that, by magnetic attraction, the central magnet 32 defines a stable position of the magnet 30 borne by the return component 16 and therefore a stable position of the lever 10, the gap between both magnets 30 and 32 having a relatively small value, for example of the order of 1 to 2 mm.

When the lever 10 is displaced from its neutral position in the direction indicated by one of the arrows 22, the magnet 30 borne by the return component 16 is brought facing one of the two other magnets 36, 38, the polarity of which is opposite to that of the central magnet 32 so that this magnet 36 or 38 tends to push the magnet 30 of the return component 16 back into its initial position.

Also, when the lever 10 is displaced from the neutral position in the direction indicated by the other arrow 22, the magnet 30 of the return component 16 is brought facing the other permanent magnet 38 or 36 which pushes it back to its initial position. The magnets 36 and 38 therefore exert on the permanent magnet 30 forces for restoring the lever 10 back to its neutral position, when this lever was displaced in selection mode.

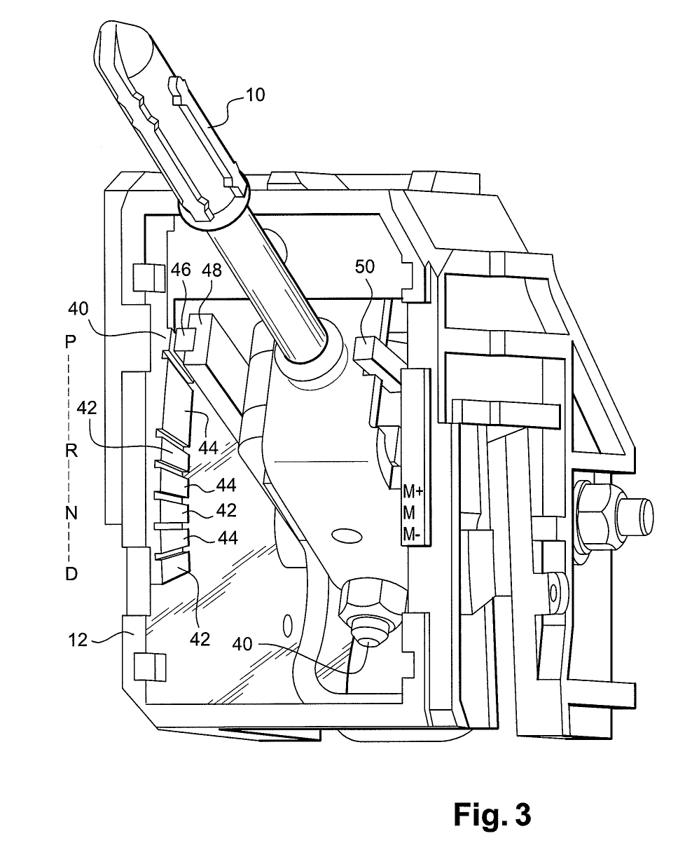

The return spring 26 which was illustrated in FIG. 2 may therefore be suppressed.

Whereas the devices of FIGS. 1 and 2 are intended for controlling manual gear boxes of a conventional type, the device of FIG. 3 is intended for controlling an automatic or automated gearbox with a grid of the PRND type with pulse control positions M, M+, M− for changing gear.

The lever 10 of the device of FIG. 3 is pivotably mounted around two perpendicular axes in the fixed casing 12, one of these axes being materialized by a cylindrical rod 40 and the other axes being perpendicular to the first in the plane of the drawing. The positions P, R, N and D are spaced apart parallel to the axis 40, as well as the positions M+, M and M−. Selection between the automatic forward drive control D and the pulse control for changing gears M is carried out by pivoting the lever around the axis 40.

The positions P, R, N and D are defined by permanent magnets 40 having the same polarity which are fixed on a side wall of the casing 12 in alternation with permanent magnets 42 of opposite polarity which define detent ball assemblies between the positions P, R, N and D, this row of permanent magnets being found on the trajectory covered by a permanent magnet 46 fixed on an arm 48 mounted on the lever 10 when this lever is displaced by pivoting around the axis perpendicular to the axis 40. The faces of the magnets 42 defining the P, R, N and D positions which are opposite a face of the magnet 46, have polarities opposite to that of this face of the magnet 46. The permanent magnets 44 positioned between the magnets 42 have polarities opposite to those of the magnets 42 for pushing back the magnet 46 in one direction or in the other direction when the latter is found aligned with one of the magnets 44.

The pulse control positions M, M+ and M− for changing gear are similarly defined par permanent magnets 42 and 44 attached on the opposite side wall of the casing 12, a magnet 42 defining the central position M and two magnets 44 located on either side of this magnet 42 defining the M+ and M− positions, the central position M being transversely aligned with position D.

These magnets cooperate by magnetic attraction and repulsion respectively with a permanent magnet 50 attached on the lever 10 or on a component capable of being driven by the lever when the latter is displaced from the D position to the M position by pivoting around the axis 40. The magnets 44 which define the M+ and M− positions exert on the magnet 50 attached to the lever 10, a repulsive force tending to bring it back into the central position M

When the lever 10 is brought into the D position by pivoting around the axis 42, the magnet 50 is too far away from the magnets 42 and 44 defining the M, M+ and M− positions to be influenced by the latter or else is blocked in the M position when the lever 10 is detached from the component bearing the magnet 50.

In this device, all the restoring forces and all the detent ball forces exerted on the lever 10 during its displacements between the positions P, R, N, D, M, M+ and M− are generated by permanent magnets 42 and 44 acting by magnetic attraction or repulsion on the magnets 46 and 50 borne or displaced by the lever 10.

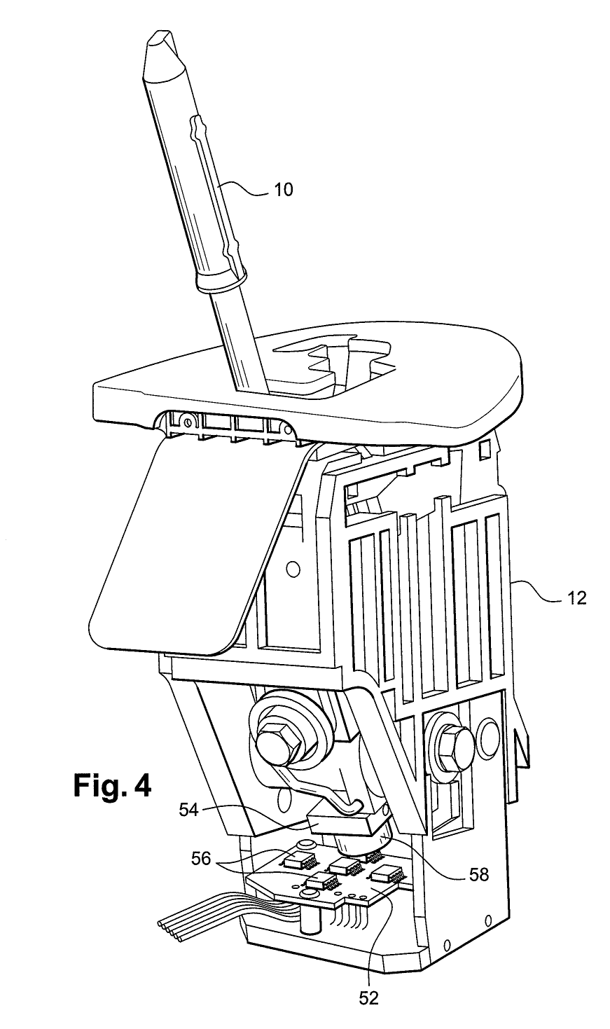

The positions and the displacements of the lever 10 are detected by a single device mounted on the base of the casing 12, as illustrated in FIG. 4, this device comprising a printed circuit 52 horizontally mounted under the lower 54 of the lever 10 and bearing magnetoresistance (or Hall effect) cells 56 which allow the directions of the magnetic field lines to be detected of a permanent magnet 58 attached at the lower end of the lever 10 and which is displaced above the printed circuit 52 during the displacements of the lever between its different positions of use. A device of this type is described in French Patent Application 06.01291 of the applicant.

The outputs of the magnetoresistance cells 56 are connected to a processing circuit, also mounted on the printed circuit 52 and with which the position of the lever may be determined by triangulation from the directions of the magnetic field lines of the magnet 58 which are detected by the cells 56.

In an alternative embodiment, the position-detecting device of FIG. 4 may be replaced with printed circuits bearing magnetoresistance (or Hall effect) cells attached on the side walls of the casings which bear the permanent magnets defining the positions P, R, N, D, M, M+ and M−, so that these cells are facing the trajectories covered by the lower ends of the permanent magnets 46 and 50 of the device of FIG. 3. In this case, the upper portions of the magnets 46 and 50 cooperate, by magnetic attraction and repulsion, with the permanent magnets 42 and 44 defining the positions P, R, N, D, M, M+ and M− as already indicated, whereas the lower portions of these magnets cooperate with the cells 56 of the printed circuits 52 for detecting the positions and the displacements of the lever 10.

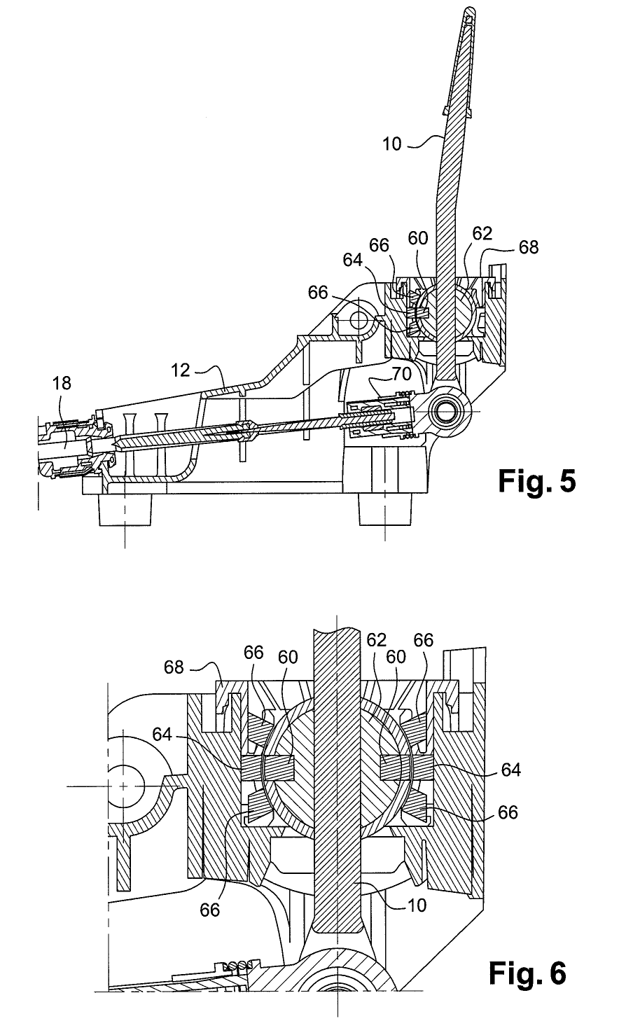

When the lever of a control device according to the invention is pivotably mounted in a casing 12 by means of a ball joint as illustrated schematically in FIG. 5, the detent ball forces upon changing gear may be generated by permanent magnets, one 60 of which is integrated to the joint ball 62 integral with the lever and the other ones of which 64 and 66 are borne by the cage 68 in which the joint ball is mounted 62. A central magnet 64 borne by the cage 68 defines by magnetic attraction of the magnet 60 of the joint ball, a stable position of the lever 10. Both other magnets 66 of the cage are located on either side of the central magnet 64 on the displacement trajectory of the magnet 60 when the lever 10 is displaced in a direction for changing gear, each magnet 66 generating by magnetic repulsion a detent ball force which needs to be overcome in order to displace the lever 10 as far as into its final position for changing gear.

It will also be noted in FIG. 5, that the lower end of the lever 10 is connected to the end of a cable or rod 10 for changing gear via an initial adjustment means 70, for example of the rack type, which specifically allows the relative positions of the magnets 60, 64 and 66 to be adjusted when mounting the device on a vehicle.

In the alternative embodiment illustrated in FIG. 6, the means illustrated in FIG. 5 for determining the stable position of the lever and the detent ball forces upon changing gear have been doubled, the joint ball 62 bearing two diametrically opposite permanent magnets 60 which each are facing a group of three permanent magnets 64, 66 borne by the cage 68 of the joint ball, both of these groups of three magnets being diametrically opposite in the plane of the drawing.

The force for holding the lever 10 in its stable position and the detent ball forces which need to be overcome upon changing gear, may thereby be doubled.

In a simple way, the joint ball 62 may be made in plastic and be overmolded on the magnet(s) 60 which are thereby directly integrated to this joint ball, which provides a reduction of the dimensional dispersions. Also, the magnets 64 and 66 formed by the cage 68 may be inserts placed into a mold during the making of the cage 68 by injection of plastic material.

The means of FIGS. 5 and 6 may advantageously be used combined with magnetic means for holding and restoring the lever back into the neutral position as illustrated in FIG. 2, for controlling a manual gearbox of a conventional type, with a control by cables or by rods or with an electrical control.

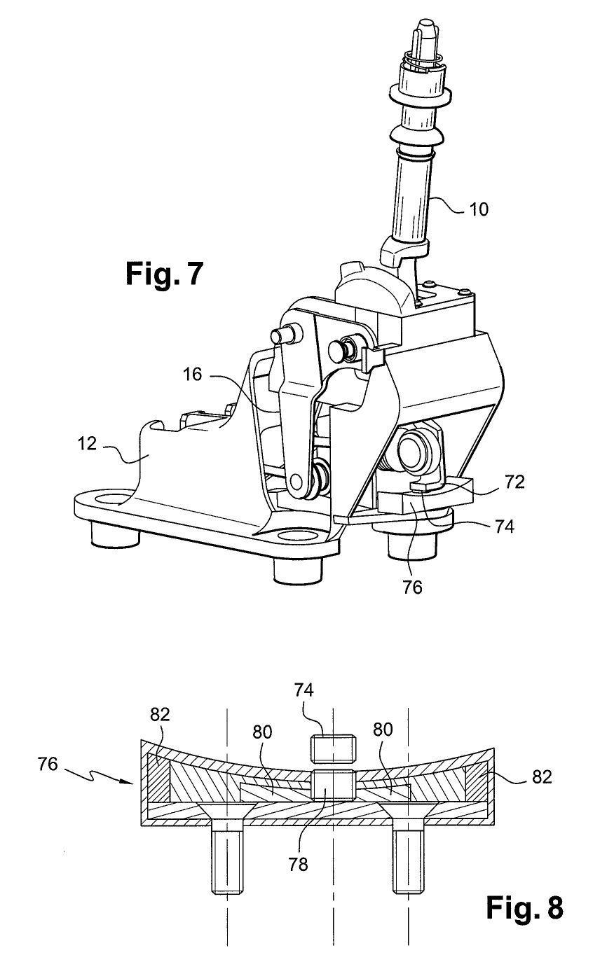

Alternatively, holding and restoring the lever into the neutral position may be provided by means illustrated in FIGS. 7 and 8.

A control device of the same type as those illustrated in FIGS. 2 and 5 is found in FIG. 7, but wherein the lower end of the lever 10 forms a horizontal edge 72 under which is attached a permanent magnet 74 displaceable above the convex curved surface of a magnetic holding and restoring block 66 when the lever 10 is displaced in the selection direction 22, this block 76 being illustrated as a sectional view in FIG. 8. This block substantially comprises a permanent magnet 78 positioned in its centre, in order to be aligned with the permanent magnet 74 of the lower end of the lever 10 in the neutral gear position and to hold this lever in this position by magnetic attraction from the magnet 74. This central magnet 78 is surrounded by two permanent magnets of opposite polarity, both magnets being found in close vicinity or in contact with the central magnet 78 in the direction of displacement of the lower end of the lever 10 in selection mode.

The block 76 includes two other permanent magnets 82 at its ends, which are in the alignment of the magnets 78 and 80 and which have a polarity identical with that of the magnet 74 of the lower end of the lever, in order to return the lever back towards its neutral gear position when it has been brought into a selection position where the magnet 74 is substantially at right angles to one of the magnets 82 of the block 76.

The upper face of this block is curved in a way matching the trajectory of the lower end of the lever 10 displaced in its selection directions in order to maintain a substantially constant gap between the magnet 74 and the lower end of the lever and the magnets, 78, 81 and 82 respectively of the block 76, this gap being for example from about 1 to 2 mm.

1. A device for controlling a gearbox for a motor vehicle, comprising a lever displaceable between predetermined neutral gear, gear selection and gear change positions, the device comprising at least one permanent magnet borne by a component integral with the lever or displaced by the latter, and permanent magnets of opposite polarities positioned in alternation on a fixed support along the path covered by the permanent magnet displaced by the lever in order to define positions of the lever and detent ball forces or restoring forces applied to the lever and to reduce the plays of the lever.

2. The device according to claim 1, wherein the component associated with the lever actuates a selection cable or rod, and the fixed support bears a central permanent magnet with a polarity opposite to that of the permanent magnet of the component associated with the lever, and which is placed between two permanent magnets with a polarity identical to that of the permanent magnet of the component associated with the lever and which generate a restoring force in selection mode of the lever.

3. The device according to claim 1, wherein the lever bears a joint ball mounted so as to rotate in a cage borne by the fixed support and the joint ball and the cage bear permanent magnets with paired polarities in order to define a median position of the lever and two detent ball points located on either side of this median position.

4. The device according to claim 3, wherein the joint ball bears a permanent magnet displaceable in front of three permanent magnets borne by the cage, these three magnets comprising a central magnet with a polarity opposite to that of the magnet borne by the joint ball and two end magnets with the same polarity as the magnet of the joint ball in order to define detent ball points upon changing gear.

5. The device according to claim 3 wherein the joint ball bears two diametrically opposite permanent magnets and the cage bears two groups of three magnets with alternate polarities, each group of three magnets of the cage being found along the path covered by a permanent magnet of the joint ball.

6. The device according to claim 1, for controlling an automatic or automated gearbox of the P, R, N, D type with pulse control positions (M, M+ and M−) for changing gears, wherein the P, R, N, D and M positions of the lever are defined by a permanent magnet borne by a component integral with the lever and by a group of permanent magnets borne by the fixed support and positioned along the path covered by the permanent magnet displaced in the P, R, N and D positions, in alternation with permanent magnets of opposite polarity which define detent ball points between the P, R, N and D positions.

7. The device according to claim 6, wherein the position M of the lever is defined by a permanent magnet borne by the lever or by a return component which is displaceable by the lever between the M+ and M− positions when the lever is in the M position, and by a permanent magnet of opposite polarity mounted on the fixed support between two permanent magnets with the same polarity as the magnet of the lever or of the return component, which define detent ball points and restoring forces in the M+ and M− positions of the lever.

8. The device according to claim 6, wherein the permanent magnets borne by the lever or by the associated components are displaceable facing printed circuits bearing magnetoresistance cells, the outputs of which are connected to a processing circuit determining the positions of the lever from the positions of the magnetic field lines detected by the cells.

9. The device according to claim 6, wherein the lever bears a permanent magnet displaced facing a printed circuit mounted on the fixed support and bearing magnetoresistance cells, the outputs of which are connected to a processing circuit determining the position of the lever by triangulation from the directions of the magnetic field lines detected by the cells.

10. The device according to claim 9, wherein the permanent magnet is borne by the lower end of the lever and the cells are laid out on the printed circuit in order to detect the presence of the lever in the P, R, N, D, M, M+ and M− positions and the displacements of the lever between these positions.

11. The device according to claim 1, wherein the lower end of the lever bears a permanent magnet located facing a block for holding and restoring the neutral gear position, comprising a central permanent magnet, two second magnets with a polarity opposite to that of the central magnet and which are mounted on either side of the central magnet on the trajectory of the end of the lever displaced in its selection directions from the neutral gear point in order to generate forces for holding the lever in the neutral gear position, and two other magnets mounted on either side of the second magnets in the selection directions of the lever in order to generate forces for restoring the lever back to the neutral gear position when the lever is in a selection position.

12. The device according to claim 1, wherein the permanent magnets mounted on the fixed support are borne by magnetic shielding plates.
